(19) United States
(12) Patent Application Publication
(10) Pub. No.: US 2026/0292886 A1
(43) Pub. Date: Sep. 24, 2026

(54) Timing Advance Management in Wireless Communications

(71) Applicant: Apple Inc., Cupertino, CA (US)

(72) Inventors: Hong HE, San Jose, CA (US); Chunxuan YE, San Diego, CA (US); Dan WU, Beijing (CN); Dawei ZHANG, Saratoga, CA (US); Haitong SUN, Saratoga, CA (US); Wei ZENG, Saratoga, CA (US)

(21) Appl. No.: 19/471,783

(22) PCT Filed: Apr. 4, 2023
(86) PCT No.: PCT/CN2023/086162

§ 371 Date: Oct. 2, 2025

(51) Int. Cl. H04W 74/0833; H04W 52/50; H04W 56/00; H04W 72/231; H04W 72/232

(52) U.S. Cl. CPC H04W 74/0833; H04W 52/50; H04W 56/0045; H04W 72/231; H04W 72/232

(57) ABSTRACT

A user equipment (UE) is configured to determine to send an uplink (UL) transmission to a network, determinw a timing advance group (TAG) associated with the UL transmission and transmit the UL transmission based on at least parameters associated with the TAG. A UE is also configured to receive a Physical Random Access Channel (PRACH) configuration for a candidate cell comprising whether the candidate cell supports random access response (RAR) skipping in response to a PRACH, receive a Physical Downlink Control Channel (PDCCH) downlink control information (DCI) order (PDCCH-order DCI) for the UE to trigger a PRACH transmission to the candidate cell and perform a PRACH procedure with the candidate cell according to the PRACH configuration, wherein the PRACH procedure comprises transmitting the PRACH to the candidate cell.

### TECHNICAL FIELD

The present disclosure generally relates to wireless communication, and in particular, to timing advance management in wireless communications.

### BACKGROUND

A user equipment (UE) may be connected to a base station. The base station may control multiple transmission and reception points (TRPs). When the UE transmits an uplink (UL) transmission, the UL transmission may be associated with a timing advance (TA) that is used to control the timing of UL transmissions. The TA may be associated with a particular TA group (TAG). In some circumstances the UE is not aware of the TAG that is associated with the UL transmission and therefore is unaware of the correct TA to apply to the UL transmission.

In addition, for layer 1/layer 2 (L1/L2)-triggered mobility (LTM), there may be circumstances where the UE does not need to provide a random access response (RAR) during a Physical Random Access Channel (PRACH) procedure. However, when RAR is skipped there may again be an issue with the UE understanding the TA that is to apply to UL transmissions.

### SUMMARY

Some exemplary embodiments are related to a method performed by a user equipment (UE). The method includes determining to send an uplink (UL) transmission to a network, determining a timing advance group (TAG) associated with the UL transmission and transmitting the UL transmission based on at least parameters associated with the TAG.

Other exemplary embodiments are related to a method performed by a user equipment (UE). The method includes receiving a Physical Random Access Channel (PRACH) configuration for a candidate cell comprising whether the candidate cell supports random access response (RAR) skipping in response to a PRACH, receiving a Physical Downlink Control Channel (PDCCH) downlink control information (DCI) order (PDCCH-order DCI) for the UE to trigger a PRACH transmission to the candidate cell and performing a PRACH procedure with the candidate cell according to the PRACH configuration, wherein the PRACH procedure comprises transmitting the PRACH to the candidate cell.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary arrangement for dynamic TAG indication for two TAs in the case of multi-DCI (mDCI) multi-TRP (mTRP) according to various exemplary embodiments.

FIG. 5A shows an example of a serving cell configuration to signal RAR skipping according to various exemplary embodiments.

FIG. 5B shows an example of a common configuration to signal RAR skipping according to various exemplary embodiments.

FIG. 6 shows an example of a Physical Downlink Control Channel (PDCCH)-order DCI format including a transmission power command (TPC) field and a new PRACH indicator (NPI) field according to various exemplary embodiments.

FIG. 7 shows an exemplary transmission power graph illustrating use of a Power Ramping Counter (PRC) field for PRACH retransmission power control according to various exemplary embodiments.

FIG. 8 shows an exemplary transmission power graph illustrating use of the NPI field for PRACH retransmission power control according to various exemplary embodiments.

FIG. 9 shows an example of RACH configuration information for multiple candidate cells according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) associating a timing advance group (TAG) to UL transmissions. The exemplary embodiments also relate to a UE determining whether a random access response (RAR) skipping mechanism is to apply to a Physical Random Access Channel (PRACH) procedure being performed between the UE and a candidate cell.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network or a gNB is merely provided for illustrative purposes. The exemplary embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The exemplary embodiments are also described with reference to specific message names and/or the names of specific information elements (IEs). It should be understood that these names are only exemplary and the information being conveyed in the messages and/or IEs may be conveyed in messages or IEs that have different names or do not have a name.

Some exemplary embodiments are described with reference to layer 1/layer 2 (L1/L2)-triggered mobility (LTM) triggered PRACH procedures. It should be understood that the exemplary embodiments are not limited to LTM triggered PRACH procedures but may also be used in other PRACH procedures.

According to the exemplary embodiments, a UE may associate a timing advance group (TAG) with a UL transmission. The association may be based on the type of UL transmission, e.g., a UL transmission triggered by downlink control information (DCI) or a UL transmission that is not triggered by DCI. This association allows the UE to use the correct timing advance (TA) for the UL transmission.

Furthermore, according to the exemplary embodiments, a UE may determine whether a random access response (RAR) skipping mechanism is to apply to a Physical Random Access Channel (PRACH) procedure being performed between the UE and a candidate cell. The exemplary embodiments provide manners for the UE to determine whether the RAR skipping is enabled. In addition, the exemplary embodiments provide manners of determining a transmission power for retransmissions during the PRACH procedure and also allow the UE to perform PRACH transmissions to multiple candidate cells.

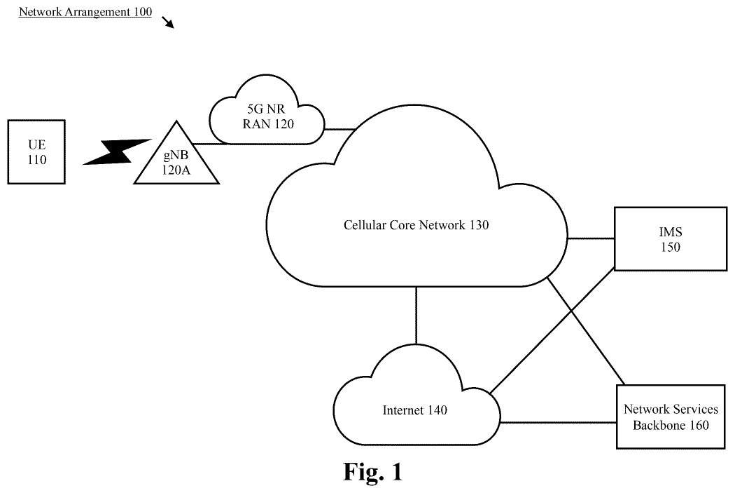

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes.

Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

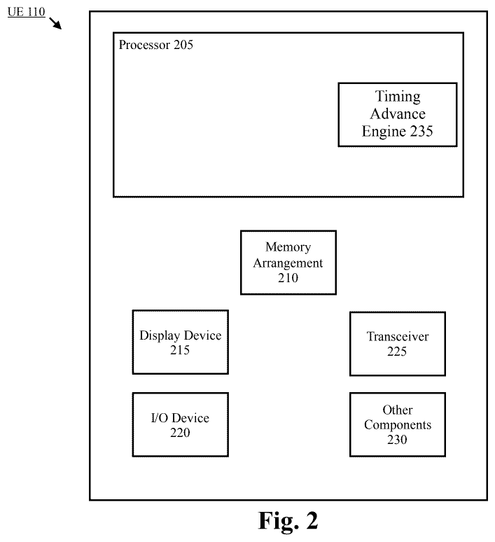

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a timing advance engine 235. The timing advance engine 235 may perform various operations related to UL transmissions performed by the UE. These operations include, but are not limited to, associating a timing advance group (TAG) with a UL transmission, determining whether a RAR skipping mechanism is to apply to a PRACH procedure, determining a transmission power for retransmissions during the PRACH procedure and also allowing the UE to perform PRACH transmissions to multiple candidate cells. These and other operations will be described in greater detail below.

The above referenced engine 235 being applications (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

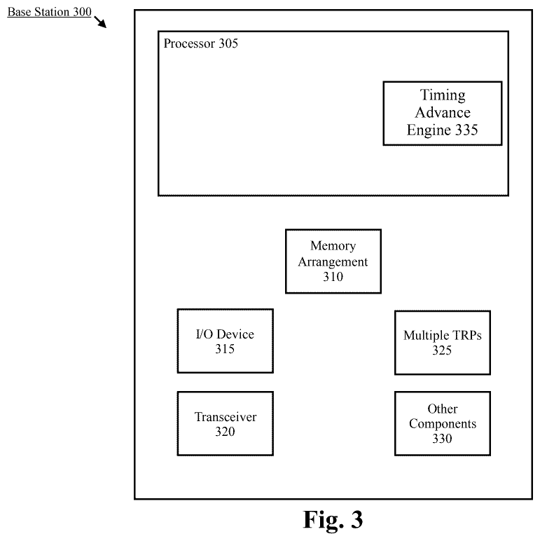

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 330 may include, for example, an audio input device, an audio output device, a battery, a data acquisition device, ports to electrically connect the base station 300 to other electronic devices and/or power sources, TxRUS, transceiver chains, antenna elements, antenna panels, etc.

The processor 305 may be configured to execute a plurality of engines for the base station 300. For example, the engines may include a timing advance engine 335 that may perform various operations related to configuring a UE with timing advance and other information for UL transmissions. These operations include, but are not limited to, indicating a timing advance group (TAG) for UL transmissions, configuring the UE with information related to whether a RAR skipping mechanism is to apply to a PRACH procedure with candidate cells, providing configuration information to allow the UE to determine a transmission power for retransmissions during the PRACH procedure and also allowing the UE to perform PRACH transmissions to multiple candidate cells. These and other operations will be described in greater detail below.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

Those skilled in the art will understand that a base station (e.g., gNB 120A) may provide a timing advance (TA) command to a UE (e.g., UE 110). The TA may be used by the UE 110 to control the timing of uplink (UL) transmissions. In some scenarios, the TA may be applied to UL transmissions to multiple base stations that are grouped together, called a timing advance group (TAG). The TAG may comprise one or more serving cells, one or more secondary cells and/or one or more TRPs.

However, there is no current mechanism to handle TAG association when Rel-15/16 spatial relation framework is used for Physical Uplink Control Channel (PUCCH) transmissions, Dynamic Grant (DG) /Configured Grant (CG) Type 1/Type 2 Physical Uplink Shared Channel (PUSCH) transmissions, aperiodic (AP) semi-periodic (SP) or periodic (P) sounding reference signals (SRS).

The exemplary embodiments provide a variety of approaches to determine the TAG association for UL transmissions in these scenarios. In the exemplary embodiments, it may be considered that there are two categories of UL transmissions. A first category is UL transmissions that are not triggered by Downlink Control Information (DCI). A second category is UL transmissions that are triggered by DCI.

For the first category of UL transmissions (e.g., those not triggered by DCI), Radio Resource Control (RRC) signaling may be used to provide the corresponding TAG for the UL transmission. These type of transmissions may include, for example, periodic SRS resource set used for code block (CB), non-CB (NCB), antenna switching (AS) or beam management (BM). The transmissions may also include a Type-1 PUSCH transmission. For Type-1 PUSCH transmissions, the TAG identification (TAG-ID) may be configured as part of the ConfiguredGrantConfig information element (IE). Another example transmission of the first category may be a PUCCH transmission without a Hybrid Automatic Repeat Request Acknowledgment (HARQ-ACK) information bit. In some exemplary embodiments, the TAG-ID for this type of UL transmission may be configured for each PUCCH-spatialRelationInfo in a PUCCH-Config. In other exemplary embodiments, for frequency range 1 (FR1) without PUCCH-spatialRelationInfo, the TAG-ID may be directly provided for each PUCCH resource.

For the second category of UL transmissions (e.g., those triggered by DCI), the TAG association may be determined using the following. In some exemplary embodiments, two TAG-IDs may be either implicitly associated with two CORESETpoolIndex values or explicitly configured to associate with two CORESETpoolIndex values. The UE will use the TAG-ID associated with the CORESETpoolIndex value of the CORESET where the triggering DCI is detected.

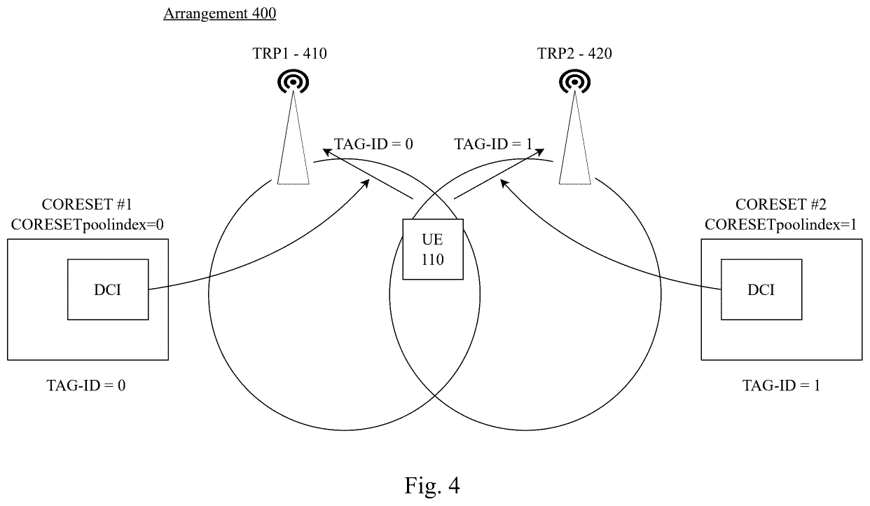

FIG. 4 shows an exemplary arrangement 400 for dynamic TAG indication for two TAS in the case of multi-DCI (mDCI) multi-TRP (mTRP) according to various exemplary embodiments. In this example, it may be considered that a DG-PUSCH is scheduled for the UE 110 by DCI format 0_1 and the TAG-ID is associated using the exemplary embodiments described above. In this example, it may be considered that the TAG-ID #0 is associated with CORESETpoolIndex=0 (e.g., TRP#1 410) and TAG-ID #1 is associated with ‘CORESETpoolIndex=1’ (e.g.,, TRP #2 420). As described above, this association may be implicit (e.g., the lower TAG-ID is associated with the lower CORESETpoolIndex) or the association may be explicit (e.g., the association may be signaled in RRC signaling to the UE).

The TAG-ID #0 may be used for the PUSCH if DCI is detected in a CORESET with ‘CORESETpoolIndex=0’. While, TAG-ID #1 is used for PUSCH if DCI is detected in a CORESET with ‘CORESETpoolIndex=1’. This provides a mechanism for the network to achieve Dynamic Point Selection (DPS) for PUSCH transmissions in a mTRP scenario.

In other exemplary embodiments, for the second category of UL transmissions (e.g., those triggered by DCI), a TAG-ID may be dynamically indicated by the triggering DCI by adding a new 1-bit field, which supports cross-TRP PUSCH scheduling. For example, a value of ‘0’ in the 1-bit field indicates a smaller TAG-ID and a value of ‘1’ indicates a larger TAG-ID.

In some exemplary scenarios, Contention Free Random Access (CFRA) may be triggered before a cell-switch command and a TA value can be provided in the cell switch command Medium Access Control Control Element (MAC-CE). In the current random access channel (RACH) procedure, a random access response (RAR) is transmitted in response to a received preamble. For a L1/L2-triggerd mobility (LTM) procedure, the RAR transmission may be skipped to minimize signaling overhead, considering the TA can be provided in cell-switching command. On the other hand, omitting the RAR transmission requires the network to store the TA values for different target cells. Thus, there is a need to implement the RAR skipping feature for CFRA procedure of LTM operation taking into account the impacts on both the network and the UE.

The exemplary embodiments may configure the UE as to whether a cell requires a RAR for CFRA for LTM. In some exemplary embodiments, the configuration may be provided by the serving cell either through System Information Block (SIB) information or dedicated RRC signaling on a per UE-basis.

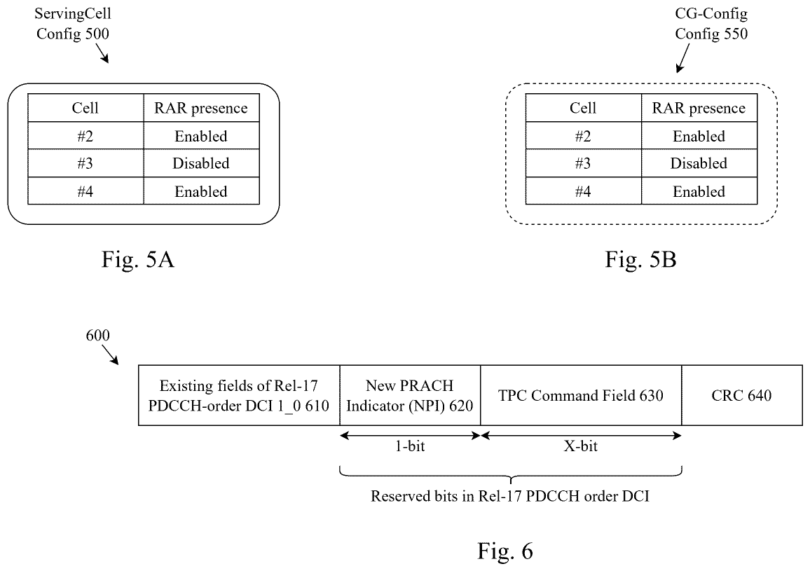

FIG. 5A shows an example of a serving cell configuration 500 to signal RAR skipping according to various exemplary embodiments. In this example, it may be considered that the serving cell is cell #1 and the candidate cells are cell #2-cell #4. In the serving cell configuration 500, RAR presence may be configured independently for each candidate cell (e.g., cell #2-cell #4) of the serving cell (e.g., cell #1). It should be understood that RAR presence indicates whether the RAR is required for the particular candidate cell, e.g., enabled means the candidate cell allows RAR skipping and disabled means the candidate cell does not allow RAR skipping. As described above, this information may be determined on a per-US basis and may be signaled via SIB or RRC signaling.

In other exemplary embodiments, the configuration of RAR presence for candidate cells may be provided in a common configuration e.g., CellGroupConfig, which is separate from the serving cell configuration. This provides RAR configurability on a per candidate cell basis and avoids the duplication configuration of RAR presence and parsing candidate cell configurations before receiving a cell switching command.

FIG. 5B shows an example of a common configuration 550 to signal RAR skipping according to various exemplary embodiments. Again, in this example, it may be considered that the serving cell is cell #1 and the candidate cells are cell #2-cell #4. In the common configuration 550 (e.g., cell group configuration), RAR presence may be configured independently for each candidate cell (e.g., cell #2-cell #4) of the serving cell (e.g., cell #1). However, this configuration is not on a per-UE basis but as shown in FIG. 5B is a common pool for all candidate cells, e. g., all UEs having cell #1 as their serving cell use the same configuration for candidate cell RAR presence.

In further exemplary embodiments, RAR presence may be configured for each candidate cell configuration at the pre-configuration phase, e. g., whether a candidate cell supports RAR skipping is included in, for example, the IEs the UE receives for the candidate cell at the pre-configuration phase. Those skilled in the art will understand that when a UE is connected to a serving cell, the UE will receive configuration information for candidate cells (e.g., neighbor cells to which the UE may be handed over by the serving cell). The pre-configuration phase may include the UE receiving information about these candidate cells, e.g., the cell ID, the resources used by the candidate cell to transmit reference signals, a slot configuration, etc. Thus, the RAR presence of the candidate cell may be included in this information received during the pre-configuration phase.

The above exemplary embodiments discussed the manners of configuring the UE with information as to whether candidate cells supported RAR skipping. However, the network may also need to know whether the UE supports RAR skipping. The following exemplary embodiments provide examples of the UE informing the network as to the capability of the UE to support RAR skipping.

In some exemplary embodiments, a UE capability may be introduced to allow the UE to indicate one of three values RAR configurations for the LTM procedure. The three configurations may include (1) RAR only, (2) RAR skipping only, (3) both RAR and RAR skipping. In other exemplary embodiments, a baseline capability may be introduced which is mandated to be supported by any LTM-capable UE. For example, the baseline capability may be either ‘RAR only’ or ‘RAR skipping only’. The network may then assume that all LTM UEs support this baseline capability.

As described above, the exemplary embodiments support the transmission of PRACH without follow-up RAR (e.g., RAR skipping) for the LIM procedure. In such a scenario, there may be cases where the candidate cell did not receive the PRACH transmission, which causes the serving cell to repeat the PDCCH order to trigger additional PRACH transmissions. For each successive PRACH transmission (e.g., PRACH retransmissions), the UE should increase the PRACH transmission power such that network (e.g., candidate cell) can eventually detect the PRACH. The exemplary embodiments also address manners of controlling the transmission power for PDCCH-ordered PRACH retransmissions.

In some exemplary embodiments, the UE is provided a set of power control parameters for each candidate cell during the pre-configuration phase. Examples of other information received by the UE for candidate cells during the pre-configuration cell were described above. The power control parameters received during the pre-configuration phase may include a transmission power of a Synchronization Signal Block (SSB) to determine the pathloss for PRACH transmissions, a power ramping step, and a maximum number of Preamble transmissions for a PDCCH-order (e.g., ‘preambleTransMax’) . Since the UE is pre-configured with this information for each candidate cell, when the UE receives a PDCCH order for a PRACH retransmission, the UE will understand the power at which the UE should transmit the PRACH retransmission.

In some exemplary embodiments, the setting of the parameter ‘preambleTransMax’ to ‘1’ implicitly indicates to the UE that RAR skipping is enabled. This use of the ‘preambleTransMax’ parameter to implicitly indicate that RAR skipping is enabled for a candidate cell may alleviate the need to introduce a separate IE to explicitly indicate the ‘enable/disable’ of RAR skipping for a given candidate cell, e.g., the above exemplary embodiments related to the configurations of FIGS. 5A and 5B may not be used because the UE will understand from the value of the preambleTransMax’ parameter whether the candidate cell supports RAR skipping.

In other exemplary embodiments, a transmission power command (TPC) field and a New PRACH Indicator (NPI) field may be added into the PDCCH-order DCI format by repurposing the ‘reserved bits’ in DCI format 1_0 for the purposes of power control. FIG. 6 shows an example of a PDCCH-order DCI format 600 including a transmission power command (TPC) field 630 and a New PRACH Indicator (NPI) field 620 according to various exemplary embodiments. The PDCCH-order DCI format 600 includes the existing fields 610 for the PDCCH order, the NPI field 620, the TPC field 630 and a cyclic redundancy check (CRC) field 640. It should be understood that while the examples provided herein are related to the DCI format 1_0 PDCCH order, the new fields may be added to any other DCI format that supports a PDCCH order.

The NPI field 620 may have a size of 1 bit, where the value ‘0’ indicates the triggered PRACH is an initial transmission of the PRACH and the value ‘1’ indicates the PRACH is a retransmission as the target cell did not receive the PRACH transmission. The TPC field 630 is shown as having a size of ‘X’ bits. The number of bits for the TPC field 630 may be based on the number of candidate adjustment values for the transmission power. For example, 2X candidate transmission power values may be specified, e.g., in the 3GPP standards, and the TPC field 630 may be sized an indication of any of the 2X values. In some exemplary embodiments, the 2X candidate values may include ‘0’ and one or multiple positive values. It should be understood that the value of the TPC field 630 is only applied when the NPI field 620 is set to ‘1’, e.g., the PRACH transmission is a retransmission, otherwise, the TPC field 630 may remain reserved.

The following provides an example of applying the value indicated in the TPC field 630. In a first example, the value indicated by TPC field 630 in the PDCCH-order DCI format 600 that triggers the PRACH transmission ‘i’ may be denoted as δ_{PRACH}(i). The UE may then set the transmission power (P_{PRACH}(i) for the retransmitted PRACH transmission ‘i’ as follows: P_{PRACH}(i)=min{P_{CMAX}(i), P_{PRACH}(i−1)+δ_{PRACH}(i)} where P_{CMAX}(i) is the UE configured maximum output power within the transmission occasion ‘i’.

In still further exemplary embodiments, a new Power Ramping Counter (PRC) field may be introduced in the PDCCH order DCI format by repurposing the reserved bits, e.g., the PRC field may be included in the PDCCH order DCI format rather than the TPC field 630. The UE may then determine the transmission power P_{PRACH}(i) for a retransmission (i) based on the value indicated by the PRC field as follows: P_{PRACH}(i)=min{P_{CMAX}(i), P₀+(X−1)*S+PL}, where P₀ is the received target power for PRACH, ‘S’ represents a power ramping step size and ‘PL’ is a pathloss based on the DL RS associated with the PRACH transmission. Both ‘P0’ and ‘S’ may be preconfigured for a candidate cell during the pre-configuration phase. The value ‘X’ is indicated by PRC field.

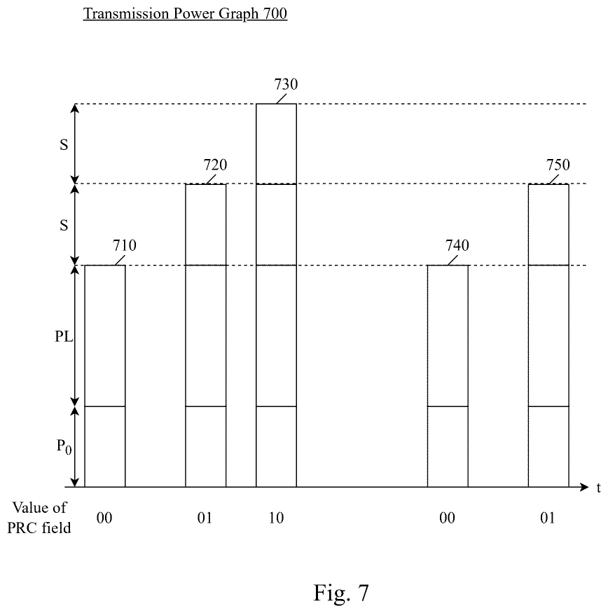

FIG. 7 shows an exemplary transmission power graph 700 illustrating use of the PRC field for PRACH retransmission power control according to various exemplary embodiments. Initially, as described above, the received target power for PRACH (P₀), the transmission power associated with the pathloss (PL) and the power ramping step size (S) are shown on the vertical axis of the transmission power graph 700. The manner of the UE acquiring the values for these variables was described above. The x axis of the transmission power graph 700 shows the value (e.g., X) of the PRC field that corresponds to the transmission. In this example, it is considered that the PRC field has a size of two bits but it should be understood that this is only exemplary and other size bit fields may be used.

The transmission power graph 700 shows the transmission power 710 associated with an initial PRACH transmission to a candidate cell. When the UE is to send a PRACH transmission to the candidate cell, the serving cell will send a DCI based PDCCH order to the UE requesting the UE to send the PRACH transmission to the candidate cell. The DCI based PDCCH order will include the PRC field. In this example, the PRC field has a value of ‘00’ indicating that the transmission is an initial transmission. When the UE decodes this value of the PRC field, the UE will understand that no transmission power control associated with a retransmission is to be applied to this PRACH transmission because it is an initial transmission. Thus, the transmission power associated with this PRACH transmission is the P₀+PL as shown in FIG. 7. It should also be understood that since it is possible for the value of the PRC field to indicate whether the current PRACH transmission is an initial transmission or a retransmission, this alleviates the need for the NPI field 620 for these exemplary embodiments.

The transmission power graph 700 also shows the transmission power 720 associated with a first PRACH retransmission to the candidate cell, e.g., the initial PRACH transmission associated with the transmission power 710 was not successfully received by the candidate cell so the serving cell sends another DCI based PDCCH order for the UE to retransmit the PRACH transmission to the candidate cell. In this example, the PRC field has a value of ‘01’ indicating that the transmission is a retransmission. When the UE decodes this value of the PRC field, the UE will understand that transmission power control associated with a retransmission is to be applied to this PRACH retransmission. Thus, the transmission power associated with this PRACH transmission is the P₀+PL+S as shown in FIG. 7, e.g., the initial transmission power plus one power ramping step size.

The transmission power graph 700 also shows the transmission power 730 associated with a second PRACH retransmission to the candidate cell, e.g., the initial PRACH transmission associated with the transmission power 710 and the first PRACH transmission associated with the transmission power 720 were not successfully received by the candidate cell. In this example, the PRC field has a value of ‘10’ indicating that the transmission is a second retransmission. When the UE decodes this value of the PRC field, the UE will understand that transmission power control associated with a retransmission is to be applied to this PRACH retransmission. Thus, the transmission power associated with this PRACH transmission is the P₀+PL+S+S as shown in FIG. 7, e.g., the initial transmission power plus two power ramping step sizes.

In this example, it may be considered that the second PRACH retransmission was received by the candidate cell. However, since this the PRC field is a two bit field in this example, the PRC field may accommodate a third PRACH retransmission (e.g., the PRC field has a value of ‘11’). It should be understood in these examples that the serving cell that is sending the DCI based PDCCH order may keep track of the initial transmission and number of retransmissions because the serving cell is transmitting the DCI based PDCCH orders and is communicating with the candidate cell via a backhaul link, e.g., the serving cell understands if the candidate cell has successfully received the PRACH transmission (initial or retransmission(s)).

At a later time, the UE may receive another DCI based PDCCH order to send the PRACH transmission to a candidate cell. Since this is a new PRACH transmission, the DCI based PDCCH order will include a PRC field having the value ‘00’ indicating the PRACH transmission is an initial transmission. Thus, the transmission power 740 associated with this PRACH transmission is the P₀+PL as shown in FIG. 7. The process may then repeat depending on the number (if any) of retransmission that are to be performed. In this example, it may be considered that one retransmission occurs. Thus, the transmission power 750 associated with this one PRACH retransmission is the P₀+PL+S as shown in FIG. 7.

In additional exemplary embodiments, a 1-bit New PRACH Indicator (NPI) field may be introduced for PDCCH order DCI format by repurposing the reserved bits in a similar manner as was described above with reference to the NPI field 620 but without the TPC field 630. In these exemplary embodiments, the UE determines the transmission power as follows: P_{PRACH}(i)=min{P_{CMAX}(i) , P₀+(Y−1)*S+PL}, where ‘Y’ is an accumulated number of PRACH (re) transmission up to the present PDCCH-order PRACH with ‘NPI=1’. In these exemplary embodiments, the accumulation may be maintained by the UE. ‘Y’ may be reset to ‘0’ once ‘NPI=0’ is detected.

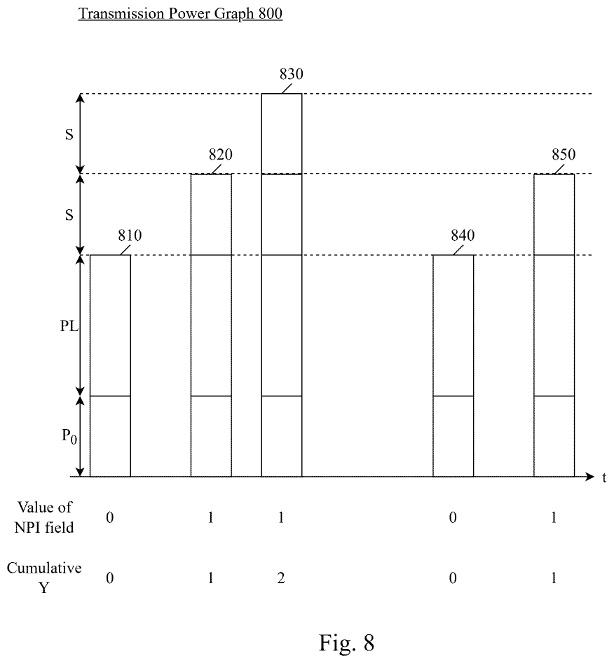

FIG. 8 shows an exemplary transmission power graph 800 illustrating use of the NPI field for PRACH retransmission power control according to various exemplary embodiments. Initially, as described above, the received target power for PRACH (P₀), the transmission power associated with the pathloss (PL) and the power ramping step size (S) are shown on the vertical axis of the transmission power graph 800. The manner of the UE acquiring the values for these variables was described above. The x axis of the transmission power graph 800 shows the value of the NPI field that corresponds to the transmission, e. g., ‘0’ indicates an initial transmission and ‘1’ indicates a retransmission. The x axis of the transmission power graph 800 also shows the cumulative value of ‘Y’ (e.g., the retransmission number) that may be maintained by the UE.

The transmission power graph 800 shows the transmission power 810 associated with an initial PRACH transmission to a candidate cell. The DCI based PDCCH order sent by the serving cell will include the NPI field. In this example, the NPI field has a value of ‘0’ indicating that the transmission is an initial transmission. When the UE decodes this value of the NPI field, the UE will understand that no transmission power control associated with a retransmission is to be applied to this PRACH transmission because it is an initial transmission. Thus, the transmission power associated with this PRACH transmission is the P₀+PL as shown in FIG. 8. In addition, the cumulative value of ‘Y’ maintained by the UE will remain ‘0’ because there are no current retransmissions associated with this PRACH transmission.

The transmission power graph 800 also shows the transmission power 820 associated with a first PRACH retransmission to the candidate cell, e.g., the initial PRACH transmission associated with the transmission power 810 was not successfully received by the candidate cell so the serving cell sends another DCI based PDCCH order for the UE to retransmit the PRACH transmission to the candidate cell. In this example, the NPI field has a value of ‘1’ indicating that the transmission is a retransmission. When the UE decodes this value of the NPI field, the UE will understand that transmission power control associated with a retransmission is to be applied to this PRACH retransmission. In addition, the UE will also increment the cumulative value of ‘Y’ from ‘0’ to ‘1’ indicating this is the first retransmission of this PRACH transmission. Thus, the transmission power associated with this PRACH transmission is P₀+PL+S as shown in FIG. 8, e.g., the initial transmission power plus one power ramping step size corresponding to the value ‘1’ of the cumulative number of retransmissions.

The transmission power graph 800 also shows the transmission power 830 associated with a second PRACH retransmission to the candidate cell, e.g., the initial PRACH transmission associated with the transmission power 810 and the first PRACH transmission associated with the transmission power 820 were not successfully received by the candidate cell. In this example, the NPI field has a value of ‘1’ indicating that the transmission is a retransmission. As can be seen from this example, unlike the example of the PRC field described above, the NPI field (e.g., the serving cell) does not maintain the number of retransmissions but only indicates whether the current PRACH transmission is an initial transmission or a retransmission. When the UE decodes this value of the NPI field, the UE will understand that transmission power control associated with a retransmission is to be applied to this PRACH retransmission. In addition, the UE will also increment the cumulative value of ‘Y’ from ‘1’ to ‘2’ indicating this is the second retransmission of this PRACH transmission. Thus, the transmission power associated with this PRACH transmission is the P₀+PL+S+S as shown in FIG. 8, e.g., the initial transmission power plus two power ramping step sizes corresponding to the cumulative value ‘Y’ of ‘2’.

In this example, it may be considered that the second PRACH retransmission was received by the candidate cell. However, the NPI field may accommodate any number of retransmissions because as described above, the NPI field is only indicating whether the PRACH transmission is an initial transmission or a retransmission. The UE may keep track of the number of retransmissions using the cumulative value ‘Y’.

At a later time, the UE may receive another DCI based PDCCH order to send the PRACH transmission to a candidate cell. Since this is a new PRACH transmission, the DCI based PDCCH order will include an NPI field having the value ‘0’ indicating the PRACH transmission is an initial transmission. When the UE decodes this value of the NPI field, the UE will understand that transmission power control associated with a retransmission is not to be applied to this PRACH retransmission. In addition, the UE will reset the cumulative value of ‘Y’ to ‘0’. Thus, the transmission power 840 associated with this PRACH transmission is the P₀+PL as shown in FIG. 8. The process may then repeat depending on the number (if any) of retransmission that are to be performed. In this example, it may be considered that one retransmission occurs. Thus, the transmission power 850 associated with this one PRACH retransmission is the P₀+PL+S as shown in FIG. 8.

In some exemplary embodiments, the network may transmit multiple PDCCH-order DCIs to trigger preamble transmissions towards different candidate cells. For example, the UE may be provided a configuration of RACH resources for each candidate cell. Each candidate cell may be identified by a logical ID or configuration ID that is provided by RRC signaling. The UE may then receive a PDCCH order DCI for PRACH for multiple candidate cells. The order may include the logical ID or configuration ID of each of the candidate cells for which PRACH is to be performed so the UE understands the candidate cells to which the PRACH transmission should be directed. The PDCCH order will be described in greater detail below. The UE may then transmit the triggered PRACH transmissions to the multiple candidate cells as ordered.

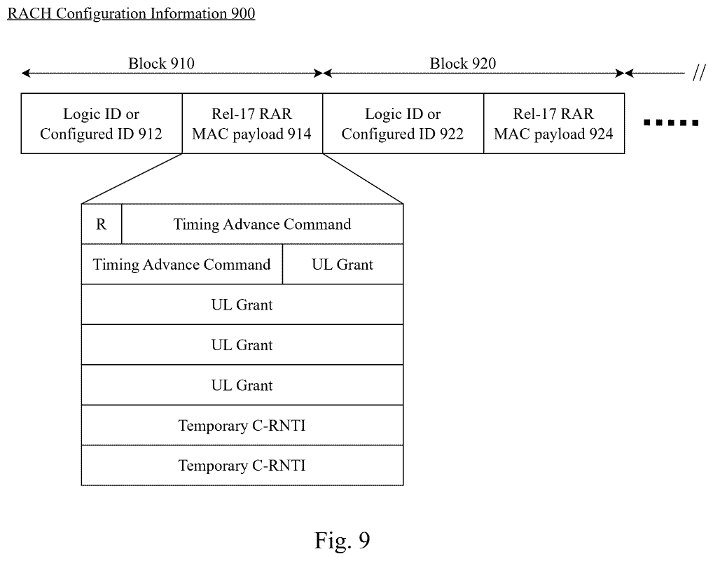

FIG. 9 shows an example of RACH configuration information 900 for multiple candidate cells received by a UE in RRC signaling according to various exemplary embodiments. As shown in FIG. 9, the RACH configuration information 900 may include a block for each candidate cell, e.g., block 910 and block 920. As shown in FIG. 9, additional candidate cells may also be included in the RACH configuration information 900. In this example, it may be considered that a first candidate cell is associated with the block 910. The block 910 includes a field 912 that identifies the logical ID or configuration ID for the first candidate cell and a field 914 that includes the RAR MAC payload (to be described in greater detail below. In FIG. 9, the RAR MAC payload is indicated as a Rel-17 MAC payload. As will be described in greater detail below, in some embodiments, the Rel-17 MAC payload is modified to accommodate an indication for multiple candidate cells. However, it should be understood that the exemplary embodiments are not limited to Rel-17 MAC payloads, other MAC payloads may also be used. Similarly, a second candidate cell is associated with the block 920. The block 920 includes a field 922 that identifies the logical ID or configuration ID for the second candidate cell and a field 924 that includes the RAR MAC payload.

FIG. 9 also shows an expanded version of the RAR MAC payload 914, e.g., a medium access control control element (MAC CE). As shown in this example, the MAC-CE may include one or more TA values for the candidate cell associated with the logical ID or configuration ID that is included in the PDCCH-order DCI.

In other exemplary embodiments, the configuration of RAR in a single MAC CE may be limited to two candidate cells. In this situation, the configuration information may not need to include the logical ID or configuration ID of the candidate cells, e.g., the block 910 in FIG. 9 may not include the field 912. Rather, the reserved bit of the MAC CE 914 shown in FIG. 9 may be repurposed to identify the candidate cell to which the TA values apply by indicating a value of ‘0’ or ‘1’. A value ‘0’ may indicate a first candidate cell that was triggered by an earlier PDCCH-order DCI for PRACH transmission. While a value ‘1’ may indicate a second candidate cell triggered by a later PDCCH-order DCI for PRACH transmission.

### EXAMPLES

In a first example, a method is performed by a user equipment (UE), comprising determining to send an uplink (UL) transmission to a network, determining a timing advance group (TAG) associated with the UL transmission and transmitting the UL transmission based on at least parameters associated with the TAG.

In a second example, the method of the first example, wherein the UL transmission is not triggered by Downlink Control Information (DCI).

In a third example, the method of the second example, wherein determining the TAG comprises receiving the TAG via radio resource control (RRC) signaling from the network.

In a fourth example, the method of the second example, wherein the UL transmission comprises aperiodic (AP) sounding reference signals (SRS), semi-periodic (SP) SRS or periodic (P) SRS.

In a fifth example, the method of the fourth example, wherein the UL transmission comprises periodic SRS comprising a SRS resource set with usage set to code block (CB), non-CB (NCB), antenna switching (AS) or beam management (BM).

In a sixth example, the method of the second example, wherein the UL transmission comprises a Physical Uplink Shared Channel (PUSCH) transmission and wherein determining the TAG comprises receiving the TAG in a radio resource control (RRC) configuration of the configured grant Physical Uplink Shared Channel (PUSCH) corresponding to the UL transmission.

In a seventh example, the method of the second example, wherein the UL transmission comprises a Physical Uplink Control Channel (PUCCH) transmission.

In an eighth example, the method of the seventh example, wherein determining the TAG comprises receiving the TAG in spatial relationship information of the PUCCH configuration.

In a ninth example, the method of the seventh example, wherein determining the TAG comprises receiving the TAG for each PUCCH resource in a PUCCH radio resource control (RRC) configuration, wherein the UL transmission is in frequency range 1 (FR1) without spatial relationship information in the PUCCH configuration.

In a tenth example, the method of the first example, wherein the UL transmission is triggered by Downlink Control Information (DCI).

In an eleventh example, the method of the tenth example, wherein the DCI is detected in a CORESET (Control Resource SET) that is configured with a value of a CORESET pool index and wherein the TAG is determined based on the value of CORESET pool index and associating the TAG based on the value of the CORESET pool index where the first TAG is associated with the value ‘0’ of the CORESET pool index and the second TAG is associated with the value ‘1’ of the CORESET pool index.

In a twelfth example, the method of the eleventh example, further comprising receiving radio resource control (RRC) signaling from the network comprising an association between CORESET pool indices and TAG information.

In a thirteenth example, the method of the tenth example, wherein the DCI comprises a field indicating an association between the TAG and the UL transmission.

In a fourteenth example, one or more processors configured to perform any of the methods of the first through thirteenth examples.

In a fifteenth example, a user equipment (UE) comprising a transceiver configured to communicate with a network and a processor communicatively coupled to the transceiver and configured to perform any of the methods of the first through thirteenth examples.

In a sixteenth example, a method performed by a user equipment (UE), comprising receiving a Physical Random Access Channel (PRACH) configuration for a candidate cell comprising whether the candidate cell supports random access response (RAR) skipping in response to a PRACH, receiving a Physical Downlink Control Channel (PDCCH) downlink control information (DCI) order (PDCCH-order DCI) for the UE to trigger a PRACH transmission to the candidate cell and performing a PRACH procedure with the candidate cell according to the PRACH configuration, wherein the PRACH procedure comprises transmitting the PRACH to the candidate cell.

In a seventeenth example, the method of the sixteenth example, wherein the PRACH configuration is a per-UE configuration and wherein the PRACH configuration is received via a System Information Block (SIB) or Radio Resource Control (RRC) signaling for a serving cell.

In an eighteenth example, the method of the sixteenth example, wherein the PRACH configuration is received in a common configuration for multiple candidate cells.

In a nineteenth example, the method of the sixteenth example, wherein the PRACH configuration is received in a configuration for the candidate cell received in a pre-configuration phase.

In a twentieth example, the method of the sixteenth example, further comprising sending an indication to a network indicating a UE capability related to support of RAR skipping, wherein the UE capability comprises one of ‘RAR only’, ‘RAR skipping only’, ‘both RAR and RAR skipping’.

In a twenty first example, the method of the sixteenth example, further comprising defining a baseline UE capability by selecting one of ‘RAR skipping’ or ‘RAR only’, wherein the baseline UE capability is required to be supported by all UEs.

In a twenty second example, the method of the sixteenth example, further comprising receiving a second PDCCH-order DCI for the UE to perform a second PRACH transmission to the candidate cell, determining the second PRACH transmission is a retransmission, determining a transmission power for the second PRACH transmission and transmitting the second PRACH transmission using the determined transmission power to the candidate cell.

In a twenty third example, the method of the twenty second example, wherein determining the transmission power comprises receiving power control configuration information for the candidate cell, wherein the power control configuration information comprises a transmission power of a Synchronization Signal Block (SSB) transmitted by the candidate cell, a power ramping step and a maximum number of preamble transmissions corresponding to the PDCCH-order DCI.

In a twenty fourth example, the method of the twenty second example, wherein the second PDCCH-order DCI comprises a value of a new PRACH indicator (NPI) field that indicates the second PRACH transmission is the retransmission and a transmission power control (TPC) field indicating one of a plurality of candidate adjustment values for the transmission power.

In a twenty fifth example, the method of the twenty fourth example, wherein at least one of the candidate values is 0.

In a twenty sixth example, the method of the twenty fourth example, wherein the transmission power is determined based on at least the one of the candidate values and a number of retransmissions corresponding to the second PRACH transmission.

In a twenty seventh example, the method of the twenty second example, wherein the second PDCCH-order DCI comprises a power ramping counter (PRC) field indicating a number of retransmissions corresponding to the second PRACH transmission, wherein the transmission power is determined based on at least the PRC field.

In a twenty eighth example, the method of the twenty seventh example, wherein the transmission power is further based on at least a received target power for PRACH for the candidate cell, a pathloss corresponding to the candidate cell and a power ramping step size.

In a twenty ninth example, the method of the twenty second example, wherein the second PDCCH-order DCI comprises a new PRACH indicator (NPI) field that indicates the second PRACH transmission is the retransmission, wherein determining the transmission power comprises incrementing a number of retransmissions based on a number of consecutive NPI fields indicating the retransmission, wherein the transmission power of the second PRACH transmission is based on at least the number of incremented retransmissions.

In a thirtieth example, the method of the twenty ninth example, wherein the transmission power is further based on at least a received target power for PRACH for the candidate cell, a pathloss corresponding to the candidate cell and a power ramping step size.

In a thirty first example, the method of the sixteenth example, wherein the PDCCH-order DCI indicates that the UE is to perform PRACH transmissions to multiple candidate cells.

In a thirty second example, the method of the thirty first example, wherein the PRACH configuration corresponds to each of the multiple candidate cells.

In a thirty third example, the method of the thirty second example, wherein the PRACH configuration comprises a plurality of blocks, each block corresponding to one of the multiple candidate cells, each block comprising an identification (ID) field indicating one of a logical ID or a configuration ID of the one of the multiple candidate cells corresponding to the block and a medium access control control element (MAC CE) field indicating one or more timing advances for the one of the multiple candidate cells corresponding to the block.

In a thirty fourth example, the method of the thirty second example, wherein the multiple candidate cells is limited to two candidate cells, wherein the PRACH configuration comprises a medium access control control element (MAC CE) including a field indicating the one of the two candidate cells for which the PRACH configuration applies.

In a thirty fifth example, one or more processors configured to perform any of the methods of the sixteenth through thirty fourth examples.

In a thirty sixth example, a user equipment (UE) comprising a transceiver configured to communicate with a network and a processor communicatively coupled to the transceiver and configured to perform any of the methods of the sixteenth through thirty fourth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
determining to send an uplink (UL) transmission to a network;
determining a timing advance group (TAG) associated with the UL transmission; and
transmitting the UL transmission based on at least parameters associated with the TAG.

2. The method of claim 1, wherein the UL transmission is not triggered by Downlink Control Information (DCI).

3. The method of claim 2, wherein determining the TAG comprises:
receiving the TAG via radio resource control (RRC) signaling from the network.

4. The method of claim 2, wherein the UL transmission comprises aperiodic (AP) sounding reference signals (SRS), semi-periodic (SP) SRS or periodic (P) SRS.

5. The method of claim 2, wherein the UL transmission comprises a Physical Uplink Shared Channel (PUSCH) transmission and wherein determining the TAG comprises:
receiving the TAG in a radio resource control (RRC) configuration of the configured grant Physical Uplink Shared Channel (PUSCH) corresponding to the UL transmission.

6. The method of claim 2, wherein the UL transmission comprises a Physical Uplink Control Channel (PUCCH) transmission.

7. The method of claim 1, wherein the UL transmission is triggered by Downlink Control Information (DCI).

8. The method of claim 7, wherein the DCI is detected in a CORESET (Control Resource SET) that is configured with a value of a CORESET pool index and wherein the TAG is determined based on the value of CORESET pool index, the method further comprising:
associating the TAG based on the value of the CORESET pool index where the first TAG is associated with the value ‘0’ of the CORESET pool index and the second TAG is associated with the value ‘1’ of the CORESET pool index.

9. The method of claim 7, wherein the DCI comprises a field indicating an association between the TAG and the UL transmission.

10. A method performed by a user equipment (UE), comprising:
receiving a Physical Random Access Channel (PRACH) configuration for a candidate cell comprising whether the candidate cell supports random access response (RAR) skipping in response to a PRACH;
receiving a Physical Downlink Control Channel (PDCCH) downlink control information (DCI) order (PDCCH-order DCI) for the UE to trigger a PRACH transmission to the candidate cell; and
performing a PRACH procedure with the candidate cell according to the PRACH configuration, wherein the PRACH procedure comprises transmitting the PRACH to the candidate cell.

11. The method of claim 10, wherein the PRACH configuration is a per-UE configuration and wherein the PRACH configuration is received via a System Information Block (SIB) or Radio Resource Control (RRC) signaling for a serving cell.

12. The method of claim 10, wherein the PRACH configuration is received in a common configuration for multiple candidate cells.

13. The method of claim 10, wherein the PRACH configuration is received in a configuration for the candidate cell received in a pre-configuration phase.

14. The method of claim 10, further comprising:
sending an indication to a network indicating a UE capability related to support of RAR skipping, wherein the UE capability comprises one of ‘RAR only’, ‘RAR skipping only’, ‘both RAR and RAR skipping’.

15. The method of claim 10, further comprising:
defining a baseline UE capability by selecting one of ‘RAR skipping’ or ‘RAR only’, wherein the baseline UE capability is required to be supported by all UEs.

16. The method of claim 10, further comprising:
receiving a second PDCCH-order DCI for the UE to perform a second PRACH transmission to the candidate cell;
determining the second PRACH transmission is a retransmission;
determining a transmission power for the second PRACH transmission; and
transmitting the second PRACH transmission using the determined transmission power to the candidate cell.

17. The method of claim 16, wherein determining the transmission power comprises receiving power control configuration information for the candidate cell, wherein the power control configuration information comprises a transmission power of a Synchronization Signal Block (SSB) transmitted by the candidate cell, a power ramping step and a maximum number of preamble transmissions corresponding to the PDCCH-order DCI.

18. The method of claim 17, wherein the second PDCCH-order DCI comprises a value of a new PRACH indicator (NPI) field that indicates the second PRACH transmission is the retransmission and a transmission power control (TPC) field indicating one of a plurality of candidate adjustment values for the transmission power.

19. The method of claim 17, wherein the second PDCCH-order DCI comprises a power ramping counter (PRC) field indicating a number of retransmissions corresponding to the second PRACH transmission, wherein the transmission power is determined based on at least the PRC field.

20. The method of claim 17, wherein the second PDCCH-order DCI comprises a new PRACH indicator (NPI) field that indicates the second PRACH transmission is the retransmission, wherein determining the transmission power comprises:
incrementing a number of retransmissions based on a number of consecutive NPI fields indicating the retransmission, wherein the transmission power of the second PRACH transmission is based on at least the number of incremented retransmissions.
